(19) United States
(12) Patent Application Publication
(10) Pub. No.: US 2026/0299458 A1
(43) Pub. Date: Oct. 1, 2026

(54) CHARGING DEVICE AND IMAGE FORMING APPARATUS

(71) Applicant: FUJIFILM Business Innovation Corp., Tokyo (JP)

(72) Inventors: Go MIURA, Kanagawa (JP); Yuki NAGAMORI, Kanagawa (JP); Taro MITSUI, Kanagawa (JP); Masaya FUKUSHIMA, Kanagawa (JP); Yudai KAMATANI, Kanagawa (JP); Ibuki MASUDA, Kanagawa (JP)

(73) Assignee: FUJIFILM Business Innovation Corp., Tokyo (JP)

(21) Appl. No.: 19/262,037

(22) Filed: Jul. 7, 2025

(30) Foreign Application Priority Data
Mar. 26, 2025 (JP) 2025-052128

(51) Int. Cl. G03G 15/02

(52) U.S. Cl. CPC G03G 15/0291; G03G 15/0266; G03G 2215/027

(57) ABSTRACT

A charging device includes: a discharge electrode; a control electrode that is disposed between the discharge electrode and a member to be charged, controls discharge of electricity from the discharge electrode, and is supported in a state where the control electrode is curved along a surface shape of the member to be charged in a lateral direction; and a cleaning section including a moving section that is supported to be movable in a longitudinal direction of the control electrode, a separation section that is fixedly supported by the moving section and comes into contact with the control electrode to push the control electrode in a direction away from the member to be charged, and a cleaning body part that comes into contact with the control electrode separated from the member to be charged by the separation section to clean the control electrode.

### CROSS-REFERENCE TO RELATED APPLICATIONS

This application is based on and claims priority under 35 USC 119 from Japanese Patent Application No. 2025-052128 filed Mar. 26, 2025.

### BACKGROUND

### (i) Technical Field

The present invention relates to a charging device and an image forming apparatus.

### (ii) Related Art

Techniques disclosed in JP 2012-185299A (Paragraph 0057 to 0075 and FIG. 3 to 7) and JP 2013-186269A (Paragraph 0020 to 0037, FIG. 2 to 4, FIG. 6, and FIG. 9 to 15) to be described below are publicly known in the related art in regard to a charger that charges the surface of an image holder in an electrophotographic image forming apparatus in the related art.

JP 2012-185299A (Paragraph 0057 to 0075 and FIG. 3 to 7) discloses a configuration in which cams (108A) are disposed at both end portions of a grid electrode plate (104) of a charging unit (100) in a longitudinal direction. In JP 2012-185299A (Paragraph 0057 to 0075 and FIG. 3 to 7), the cams (108A) are rotated at the time of charging to curve the grid electrode plate (104) along the surface of a photoreceptor (62). Further, at the time of cleaning, the cams (108A) are returned to return the grid electrode plate (104) to the shape of a flat plate, and a cleaning mechanism (110) is caused to reciprocate in the longitudinal direction.

JP 2013-186269A (Paragraph 0020 to 0037, FIG. 2 to 4, FIG. 6, and FIG. 9 to 15) discloses a configuration in which a grid (43) of a charging device (22) is curved along the surface of a photoreceptor (21). In JP 2013-186269A (Paragraph 0020 to 0037, FIG. 2 to 4, FIG. 6, and FIG. 9 to 15), in a case where discharge wires (42) or the grid (43) is cleaned, a second cleaning pad (72) comes into contact with the lower surface of the curved grid (43) and cleans the grid (43) in a state where the second cleaning pad (72) is deformed to be bent.

### SUMMARY

Aspects of non-limiting embodiments of the present disclosure relate to a charging device and an image forming apparatus that simplifies a cleaning mechanism as compared to a case where a mechanism for deforming a control electrode over the entire longitudinal direction is used to ensure a distance between a member to be charged and a cleaning section in a case where the control electrode facing the member to be charged is cleaned.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

In order to achieve the technical object, according to an aspect of the present disclosure, there is provided a charging device including: a discharge electrode; a control electrode that is disposed between the discharge electrode and a member to be charged, controls discharge of electricity from the discharge electrode, and is supported in a state where the control electrode is curved along a surface shape of the member to be charged in a lateral direction; and a cleaning section including a moving section that is supported to be movable in a longitudinal direction of the control electrode, a separation section that is fixedly supported by the moving section and comes into contact with the control electrode to push the control electrode in a direction away from the member to be charged, and a cleaning body part that comes into contact with the control electrode separated from the member to be charged by the separation section to clean the control electrode.

### BRIEF DESCRIPTION OF THE DRAWINGS

Exemplary embodiment(s) of the present invention will be described in detail based on the following figures, wherein:

FIG. 1 is an overall view of an image forming apparatus of Example 1 of the present invention;

FIG. 2 is a diagram illustrating a visible image forming device that includes an image holder unit and a developing unit;

FIG. 3 is a perspective view of a charger of Example 1 of the present invention;

FIG. 4 is a cross-sectional view of a major part of the charger of Example 1 of the present invention;

FIGS. 5A and 5B are diagrams illustrating a grid electrode of Example 1, FIG. 5A is a plan view, and FIG. 5B is a diagram illustrating a major part of a portion indicated by an arrow VB in FIG. 5A;

FIG. 6 is a diagram illustrating a major part of the charger in a state where the grid electrode is stretched;

FIG. 7 is a diagram illustrating an abutting section of Example 1;

FIGS. 8A and 8B are diagrams illustrating a pulling section of Example 1, FIG. 8A is a perspective view, and FIG. 8B is a diagram viewed in a direction of an arrow VIIIB in FIG. 8A;

FIG. 9 is a cross-sectional view of a cleaning section of Example 1;

FIG. 10 is a perspective view of a separation section of Example 1;

FIGS. 11A to 11E are diagrams illustrating an operation of the cleaning section of Example 1, FIG. 11A is a diagram illustrating a state where the cleaning section is moved to a standby position, FIG. 11B is a diagram illustrating a state where the cleaning section is moved forward from the standby position and grid guide portions are in contact with inclined surfaces, FIG. 11C is a diagram illustrating a state where the cleaning section is further moved forward from the state of FIG. 11B and the grid guide portions begin to be pushed upward by the inclined surfaces, FIG. 11D is a diagram illustrating a state where the cleaning section is further moved forward from the state of FIG. 11C and the grid electrodes are lifted upward from separation surfaces, and FIG. 11E is a diagram illustrating a state where the cleaning section is further moved forward from the state of FIG. 11D; and

FIGS. 12A and 12B are cross-sectional views of the cleaning section in a case where the cleaning section is operated, FIG. 12A is a cross-sectional view showing a state where the cleaning section is moved to the standby position, and FIG. 12B is a cross-sectional view showing the state of FIGS. 11D and 11E.

### DETAILED DESCRIPTION

Next, specific examples (hereinafter, referred to as Examples) of an exemplary embodiment of the present invention will be described with reference to the drawings. However, the present invention is not limited to the following examples.

In order to facilitate the understanding of the following description, in the drawings, a front-rear direction will be defined as an X-axis direction, a right-left direction will be defined as a Y-axis direction, and a vertical direction will be defined as a Z-axis direction. Directions or sides indicated by arrows X, −X, Y, −Y, Z, and −Z will be defined as a forward direction, a rearward direction, a rightward direction, a leftward direction, an upward direction, and a downward direction, or a front side, a rear side, a right side, a left side, an upper side, and a lower side, respectively.

Further, in the drawings, a symbol “○” with a symbol “•” therein means an arrow from the back of the plane of the sheet to the front thereof and a symbol “○” with a symbol “×” therein means an arrow from the front of the plane of the sheet to the back thereof.

In the following description using the drawings, members other than members required for description will be appropriately omitted to facilitate understanding.

### Example 1

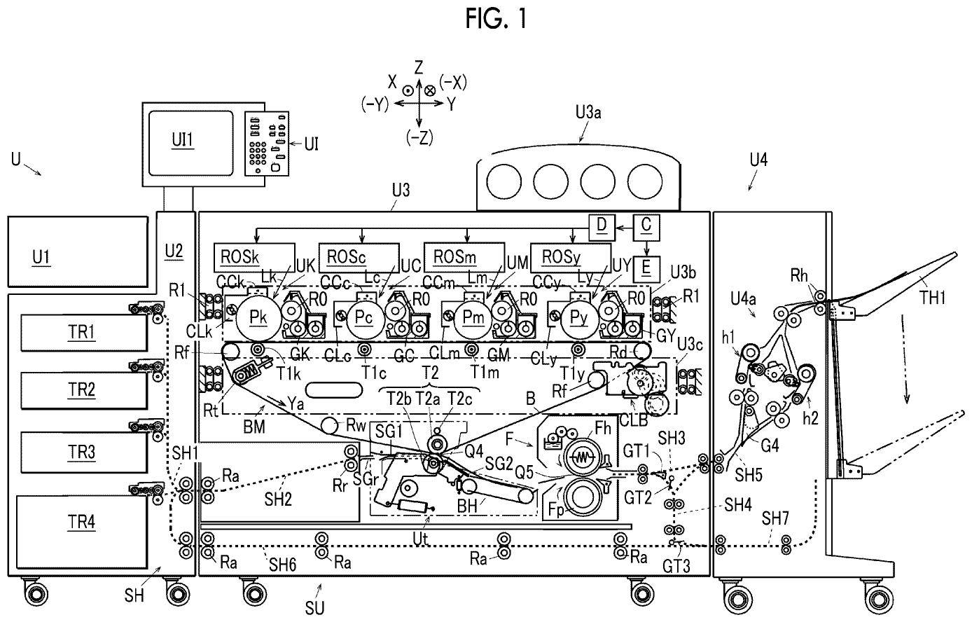

FIG. 1 is an overall view of an image forming apparatus of Example 1 of the present invention.

In FIG. 1, the image forming apparatus U includes a user interface UI as an example of an operation section, an image input device U1 as an example of an image reading section, a sheet feed device U2 as an example of a medium feed section, an image recording device U3 as an example of a body of the image forming apparatus, and a sheet processing device U4 as an example of a post-processing section.

The user interface UI includes input keys, such as a copy start key and a numeric keypad, as an example of an input section, and a display UI1.

The image input device U1 is formed of an image scanner or the like that is an example of an image reading device. In FIG. 1, the image input device U1 reads an original document (not shown) to convert the original document into image information, and inputs the image information to the image recording device U3.

The sheet feed device U2 includes sheet feed trays TR1, TR2, TR3, and TR4 as an example of a plurality of medium storage sections, a sheet feed passage SH1 through which recording sheets S as an example of mediums stored in each of the sheet feed trays TR1 to TR4 are transported, and the like.

In FIG. 1, the image recording device U3 includes an image recording unit that records an image on the recording sheet S transported from the sheet feed device U2, a toner dispenser unit U3a, a sheet transport passage SH2, a sheet discharge passage SH3, a sheet inversion passage SH4, a sheet circulation passage SH6, and the like. The image recording unit will be described later.

Further, the image recording device U3 includes a controller C as an example of a control section, a laser drive circuit D as an example of a drive circuit of a latent image writing device that is controlled by the controller C, a power source circuit E that is controlled by the controller C, and the like. The laser drive circuit D outputs laser drive signals, which correspond to image information for Y (yellow), M (magenta), C (cyan), and K (black) input from the image input device U1, to respective color latent image forming devices ROSy, ROSm, ROSc, and ROSk at preset times.

A pull-out member U3b for an image forming unit is supported below the latent image forming devices ROSy to ROSk, which are an example of a latent image forming section, by a pair of right and left guide members R1 and R1 to be movable between a pull-out position where the pull-out member U3b is pulled out to the front of the image recording device U3 and a mounting position where the pull-out member U3b is mounted inside the image recording device U3.

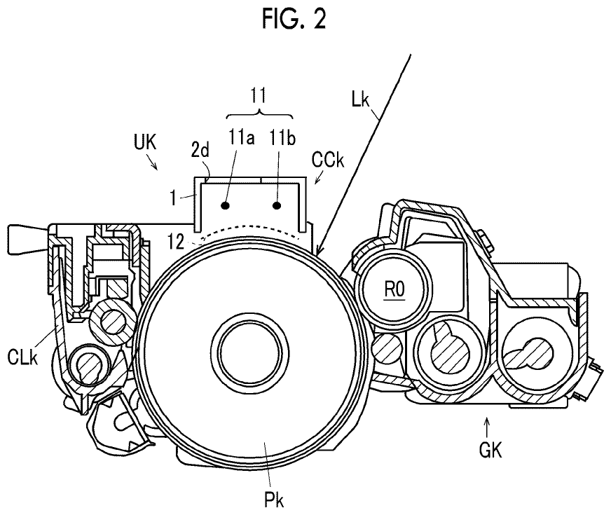

FIG. 2 is a diagram illustrating a visible image forming device that includes an image holder unit and a developing unit.

In FIGS. 1 and 2, an image holder unit UK for black includes a photoreceptor drum Pk as an example of an image holding section, a charger CCk that is an example of a charging device and an example of a charging section, and a photoreceptor cleaner CLk as an example of a cleaning section for the image holding section. In Example 1, the charger CCk is formed of a charging unit that can be attached to and detached from the image recording device U3. Further, image holder units UY, UM, and UC for the other colors Y, M, and C also include photoreceptor drums Py, Pm, and Pc, chargers CCy, CCm, and CCc, and photoreceptor cleaners CLy, CLm, and CLc. Furthermore, in Example 1, the photoreceptor drum Pk for black (K) of which the frequency of use is high and the surface is to be more worn is formed to have a larger diameter than the photoreceptor drums Py, Pm, and Pc for the other colors. Accordingly, the photoreceptor drum Pk copes with high-speed rotation and achieves a long service life.

The image holder units UY, UM, UC, and UK and developing units GY, GM, GC, and GK including developing rollers R0 constitute toner image forming members UY+GY, UM+GM, UC+GC, and UK+GK. The image holder units UY, UM, UC, and UK, and the developing units GY, GM, GC, and GK are attachably and detachably mounted on the pull-out member U3b for an image forming unit.

In FIG. 1, the photoreceptor drums Py to Pk are charged by the chargers CCy to CCk, respectively, and then electrostatic latent images are formed on the surfaces of the photoreceptor drums Py to Pk by laser beams Ly, Lm, Lc, and Lk as an example of latent image writing light output from the latent image forming devices ROSy to ROSk. The electrostatic latent images formed on the surfaces of the photoreceptor drums Py to Pk are developed into yellow (Y), magenta (M), cyan (C), and black (K) toner images by the developing units GY to GK as an example of a developing section.

The toner images on the surfaces of the photoreceptor drums Py to Pk are sequentially superimposed and transferred onto an intermediate transfer belt B, which is an example of an image holding section and an example of an intermediate transfer body, by primary transfer rollers T1y, T1m, T1c, and T1k as an example of a primary transfer section, so that a multicolor image, that is, a so-called color image is formed on the intermediate transfer belt B. The color image formed on the intermediate transfer belt B is transported to a secondary transfer region Q4.

Further, in the case of only black image data, only the photoreceptor drum Pk and the developing unit GK for black (K) are used and only a black toner image is formed.

After primary transfer, residual toner on the surfaces of the photoreceptor drums Py to Pk is cleaned off by the photoreceptor cleaners CLy to CLk.

A pull-out member U3c for an intermediate transfer body is supported below the pull-out member U3b for an image forming unit to be movable between a pull-out position where the pull-out member U3c is pulled out to the front of the image recording device U3 and a mounting position where the pull-out member U3c is mounted inside the image recording device U3. A belt module BM as an example of an intermediate transfer section is supported at the pull-out member U3c for an intermediate transfer body to be liftable and lowerable between a raised position where the belt module BM is in contact with lower surfaces of the photoreceptor drums Py to Pk and a lowered position where the belt module BM is separated downward from the lower surfaces.

The belt module BM includes the intermediate transfer belt B, a belt drive roller Rd as an example of a drive section, a tension roller Rt as an example of a tensioning section, a walking roller Rw as an example of a meandering prevention section, a plurality of idler rollers Rf as an example of a driven section, a backup roller T2a as an example of a facing section for the secondary transfer region Q4, and primary transfer rollers T1y to T1k. The intermediate transfer belt B is supported by the belt support rollers Rd, Rt, Rw, Rf, and T2a to be rotatable and movable in the direction of an arrow Ya.

A secondary transfer unit Ut is disposed below the backup roller T2a. The secondary transfer unit Ut includes a secondary transfer roller T2b as an example of a secondary transfer member. The secondary transfer roller T2b is disposed to be capable of being separated from and in contact with the backup roller T2a with the intermediate transfer belt B interposed therebetween, and a region where the secondary transfer roller T2b is in contact with the intermediate transfer belt B form the secondary transfer region Q4. Further, a contact roller T2c as an example of a voltage application section is in contact with the backup roller T2a, and the respective rollers T2a to T2c constitute a secondary transfer module T2 as an example of a secondary transfer section.

A secondary transfer voltage having a polarity identical to the charging polarity of the toner is applied to the contact roller T2c from the power source circuit E, which is controlled by the controller C, at a preset time.

The sheet transport passage SH2 is disposed below the belt module BM. The recording sheet S fed from the sheet feed passage SH1 of the sheet feed device U2 is transported to the sheet transport passage SH2, and is transported to the secondary transfer region Q4 through medium guide members SGr and SG1 before transfer by a registration roller Rr, which is an example of a section for adjusting a paper feeding time, in time with the transport of the toner images to the secondary transfer region Q4.

The toner images formed on the intermediate transfer belt B are transferred onto the recording sheet S by the secondary transfer module T2 when passing through the secondary transfer region Q4. Meanwhile, in the case of a full color image, the toner images superimposed and primarily transferred onto the surface of the intermediate transfer belt B are collectively secondarily transferred onto the recording sheet S.

The intermediate transfer belt B from which the toner images have been secondarily transferred is cleaned by a belt cleaner CLB as an example of a cleaning section for an intermediate transfer body.

The primary transfer rollers T1y to T1k, the intermediate transfer belt B, the secondary transfer module T2, the belt cleaner CLB, and the like constitute a transfer device (an example of a transfer section) T1+B+T2+CLB that transfers the images formed on the surfaces of the photoreceptor drums Py to Pk onto the recording sheet S.

The recording sheet S onto which the toner images are secondarily transferred is transported to a fixing device F through a medium guide member SG2 after transfer and a sheet transport belt BH as an example of a medium transport member before fixing. The fixing device F as an example of a fixing section includes a heating roller Fh as an example of a heating fixing section and a pressure roller Fp as an example of a pressure fixing section, and a region where the heating roller Fh and the pressure roller Fp are in contact with each other forms a fixing region Q5.

The toner images transferred onto the recording sheet S are heated and fixed by the fixing device F when passing through the fixing region Q5.

The toner image forming members UY+GY, UM+GM, UC+GC, and UK+GK and the transfer device T1+B+T2+CLB, the fixing device F, and the like constitute the image recording unit of Example 1 that records an image on the recording sheet S.

A first gate GT1 as an example of a section for switching a transport passage is provided on a downstream side of the fixing device F. The first gate GT1 selectively switches the recording sheet S, which is transported through the sheet transport passage SH2 and to which the toner images have been heated and fixed in the fixing region Q5, to either the sheet discharge passage SH3 or the sheet inversion passage SH4 of the image recording device U3. The recording sheet S transported to the sheet discharge passage SH3 is transported to a sheet transport passage SH5 of the sheet processing device U4.

A curl correction device U4a as an example of a curvature correction section is disposed in the middle of the sheet transport passage SH5, and a second gate G4 as an example of a section for switching a transport passage is disposed in the sheet transport passage SH5. The second gate G4 transports the recording sheet S, which is transported from the sheet discharge passage SH3 of the image recording device U3, toward either a first curl correction member h1 or a second curl correction member h2 depending on a direction of curvature, that is, so-called curl. The curl of the recording sheet S transported to the first curl correction member h1 or the second curl correction member h2 is corrected while the recording sheet S passes through the first curl correction member h1 or the second curl correction member h2. The recording sheet S of which the curl is corrected is discharged from a discharge roller Rh as an example of a discharge section to a discharge tray TH1 as an example of a discharge unit of the sheet processing device U4 in a state where a surface of the sheet to which the images are fixed faces upward, that is, in a so-called face-up state.

The recording sheet S, which is transported toward the sheet inversion passage SH4 of the image recording device U3 by the first gate GT1, passes through a transport direction-restricting section formed of an elastic thin film-like member, that is, a so-called miller gate GT2 while pushing the miller gate GT2, and is transported to the sheet inversion passage SH4 of the image recording device U3.

The sheet circulation passage SH6 and a sheet inversion passage SH7 are connected to a downstream end of the sheet inversion passage SH4 of the image recording device U3, and a miller gate GT3 is also disposed at a connection portion where the sheet circulation passage SH6 and the sheet inversion passage SH7 are connected to the sheet inversion passage SH4. The sheet, which is transported to the sheet inversion passage SH4 through the first gate GT1, passes through the miller gate GT3 and is transported toward the sheet inversion passage SH7 of the sheet processing device U4. In a case where two-sided printing is performed, the recording sheet S that has been transported through the sheet inversion passage SH4 passes through the miller gate GT3 and is transported to the sheet inversion passage SH7 and is then transported in a reverse direction, that is, so-called switched back. In this case, the recording sheet S of which the transport direction is restricted by the miller gate GT3 and which has been switched back is transported toward the sheet circulation passage SH6. The recording sheet S transported to the sheet circulation passage SH6 is transported to the secondary transfer region Q4 through the sheet feed passage SH1 again.

On the other hand, in a case where the recording sheet S transported through the sheet inversion passage SH4 is switched back before a rear end of the recording sheet S passes through the miller gate GT3 after passing through the miller gate GT2, the transport direction of the recording sheet S is restricted by the miller gate GT2 and the recording sheet S is transported to the sheet transport passage SH5 in a state where the recording sheet S is inverted. After the curl of the inverted recording sheet S is corrected by the curl correction device U4a, the inverted recording sheet S can be discharged to the discharge tray TH1 of the sheet processing device U4 in a state where the surface of the recording sheet S to which the images are fixed faces downward, that is, in a so-called face-down state.

The elements denoted by the reference numerals SH1 to SH7 constitute a sheet transport passage SH. Further, the elements denoted by the reference numerals SH, Ra, Rr, Rh, SGr, SG1, SG2, BH, and GT1 to GT3 constitute a sheet transport device SU.

### Description of Charger

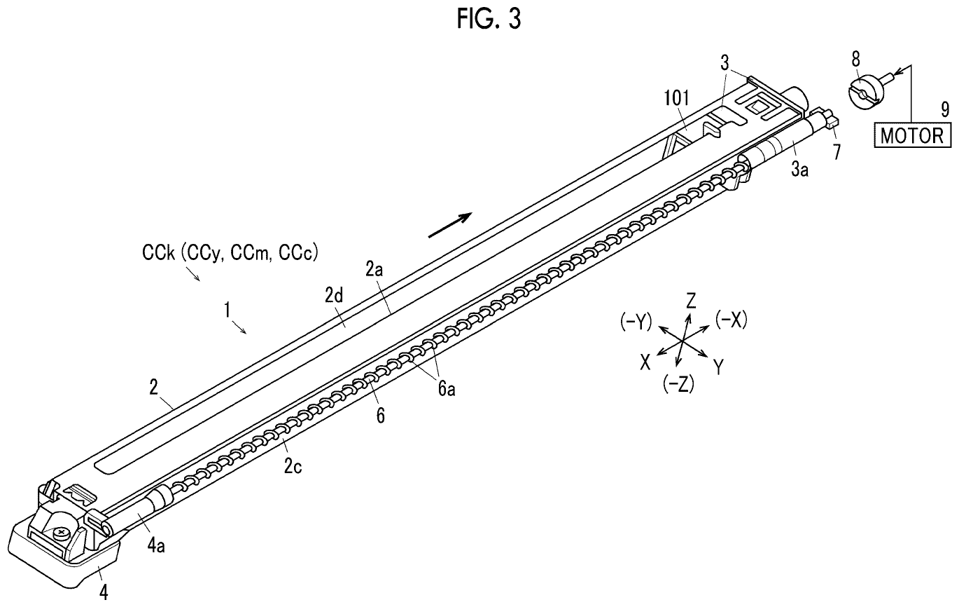

FIG. 3 is a perspective view of the charger of Example 1 of the present invention.

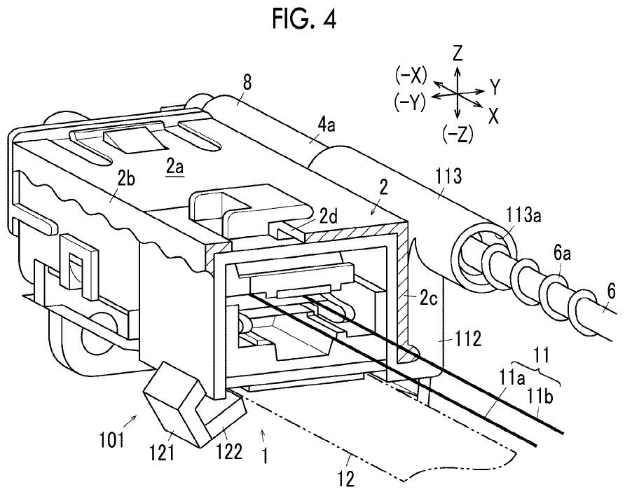

FIG. 4 is a cross-sectional view of a major part of the charger of Example 1 of the present invention.

In FIG. 4, a part of a shield electrode is not shown to facilitate the understanding of the invention.

Next, the charger of Example 1 will be described. However, since the chargers CCy to CCk for the respective colors of Y, M, C, and K have an identical configuration, the charger CCk for black (K) will be described in detail and the detailed description of the chargers CCy to CCc of the other colors will be omitted.

In FIGS. 2, 3, and 4, the charger CCk of Example 1 includes a charger body 1 that extends in the front-rear direction. The charger body 1 includes a shield electrode 2. The shield electrode 2 is made of a conductive metal material. The shield electrode 2 includes a plate-like upper wall portion 2a that extends in the front-rear direction, and plate-like left and right wall portions 2b and 2c that extend downward from both left and right sides of the upper wall portion 2a. An opening 2d extending in the front-rear direction is formed at a left portion of the upper wall portion 2a.

A rear end block 3 as an example of one end member is supported at a rear end of the shield electrode 2, and a front end block 4 as an example of the other end member is supported at a front end of the shield electrode 2. Tubular shaft receiving portions 3a and 4a extending in the front-rear direction are formed at upper right portions of the front and rear blocks 3 and 4 as an example of a support body for a movable cleaning member.

A shaft 6, which extends in the front-rear direction, as an example of a rotating member is rotatably supported by the shaft receiving portions 3a and 4a. A thread 6a is formed on an outer peripheral surface of the shaft 6. A rear end portion of the shaft 6 penetrates the rear shaft receiving portion 4a and extends rearward, and a driven coupling 7 as an example of a transmission target member is supported at the rear end of the shaft 6. A drive coupling 8 as an example of a transmission member is disposed in the image recording device U3. In a case where the charger CCk is mounted on the image recording device U3, the driven coupling 7 is supported in a state where the driven coupling 7 meshes with the drive coupling 8. The drive coupling 8 is adapted such that drive from a motor 9 for an electrode cleaner as an example of a drive source for an electrode cleaning member can be transmitted to the drive coupling 8. A motor that can be driven in a normal direction and a reverse direction is used as the motor 9 for an electrode cleaner of Example 1.

An aspect in which the shaft 6 is disposed on the right side of the charger CCk has been exemplified in Example 1, but the present invention is not limited thereto. An aspect in which the shaft 6 is disposed on the upper portion or the left side of the charger CCk may be adopted.

In FIGS. 2 to 4, a wire electrode 11, which is an example of a discharge electrode and an example of a first electrode, is disposed in the charger body 1. The wire electrode 11 of Example 1 is formed of wire rods extending in the front-rear direction. The wire electrode 11 of Example 1 includes two wires, that is, a first wire electrode 11 a and a second wire electrode 11b. Both front and rear ends of the wire electrode 11 are supported by the respective blocks 3 and 4.

A grid electrode 12, which is an example of a control electrode and an example of a second electrode, is supported at a position of a lower opening of the shield electrode 2 between the wire electrode 11 and the photoreceptor drum Pk, that is, in a charging region that is a region facing the photoreceptor drum Pk as an example of a member to be charged.

In a case where a voltage is applied to the grid electrode 12 to control electric charges in a state where power is supplied to the wire electrode 11, discharge occurs due to a potential difference between the wire electrode 11 and the grid electrode 12. The surface of the photoreceptor drum Pk is charged by released electric charges.

### Description of Grid Electrode

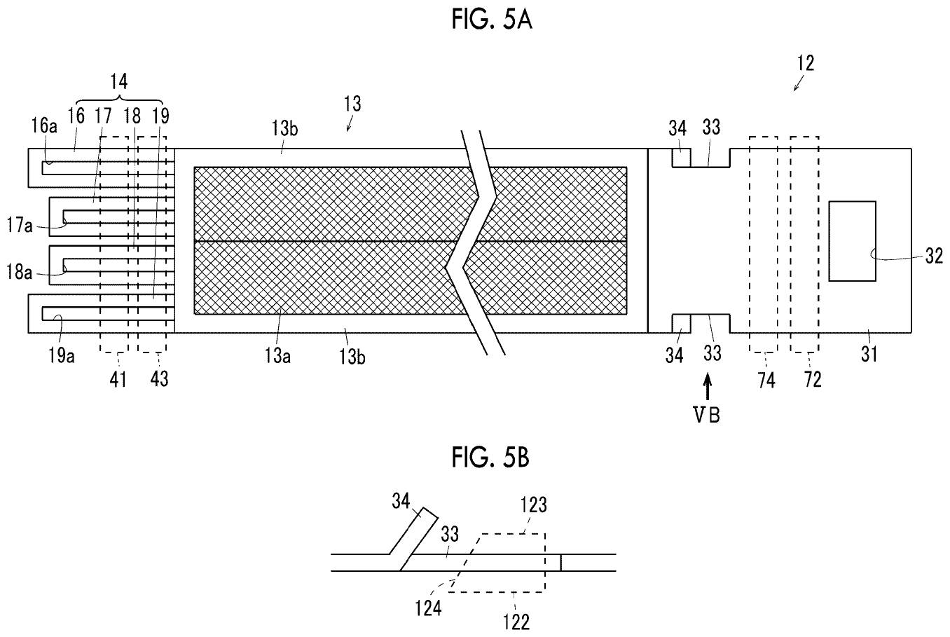

FIGS. 5A and 5B are diagrams illustrating the grid electrode of Example 1, FIG. 5A is a plan view, and FIG. 5B is a diagram illustrating a major part of a portion indicated by an arrow VB in FIG. 5A.

In FIGS. 5A and 5B, the grid electrode 12 of Example 1 includes a net-like portion 13 extending in a longitudinal direction (an axial direction of the photoreceptor drum) as an example of a net portion. The net-like portion 13 is formed in the shape of a net in which a plurality of first openings 13a are formed. Edge portions 13b as an example of beam portions are formed at both end portions of the net-like portion 13 in a width direction (a rotation direction of the photoreceptor drum, a lateral direction).

A hook portion 14 as an example of a section to be pulled is disposed at a front end portion that is an example of one end portion of the net-like portion 13 in the longitudinal direction. The hook portion 14 of Example 1 includes a first hook portion 16, a second hook portion 17, a third hook portion 18, and a fourth hook portion 19. The first to fourth hook portions 16 to 19 are arranged at intervals from one end of the net-like portion 13 in the lateral direction to the other end thereof.

Each of the first to fourth hook portions 16 to 19 is formed in the shape of a strip extending in the longitudinal direction. Openings 16a to 19a are formed in the first to fourth hook portions 16 to 19, respectively. Therefore, the first to fourth hook portions 16 to 19 of Example 1 are formed in the shape of a rectangular frame extending in the longitudinal direction.

In Example 1, in regard to the lengths of the first to fourth hook portions 16 to 19 in the longitudinal direction, the first and fourth hook portions 16 and 19, which are disposed at both ends of the net-like portion 13 in the lateral direction, are formed to be longer than the second and third hook portions 17 and 18, which are disposed on the inner side of the net-like portion 13 in the lateral direction.

A rear frame portion 31 is provided at a rear end portion that is an example of the other end portion of the net-like portion 13 in the longitudinal direction. A positioning opening 32 as an example of a portion to be positioned is formed at a rear portion of the rear frame portion 31.

Cut-out portions 33 as an example of an opening portion are formed at both end portions of a front portion of the rear frame portion 31 in the lateral direction. Grid guide portions 34 as an example of a section to be guided are formed on a front side of the cut-out portions 33. Front ends of the grid guide portions 34 are connected to the rear frame portion 31, and the grid guide portions 34 are inclined in a direction away from the photoreceptor drum Pk as the grid guide portions 34 extend toward the rear side.

### Description of Tension Applying Section

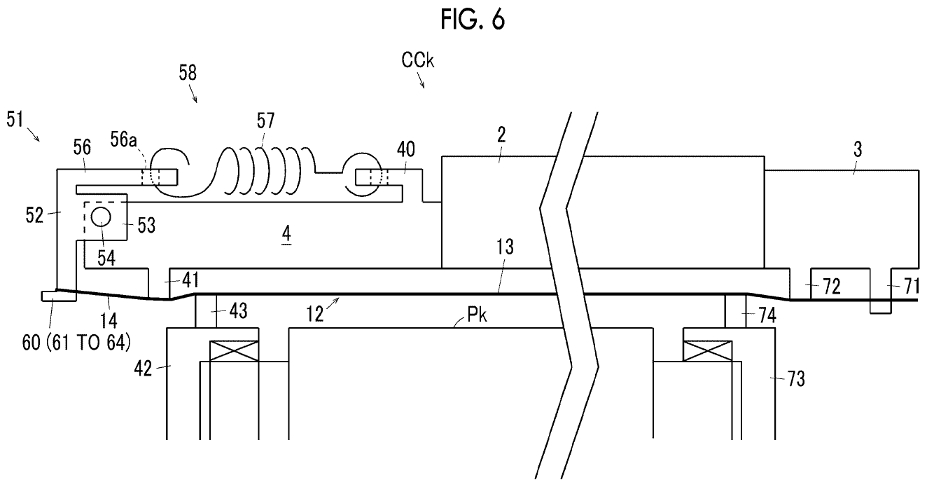

FIG. 6 is a diagram illustrating a major part of the charger in a state where the grid electrode is stretched.

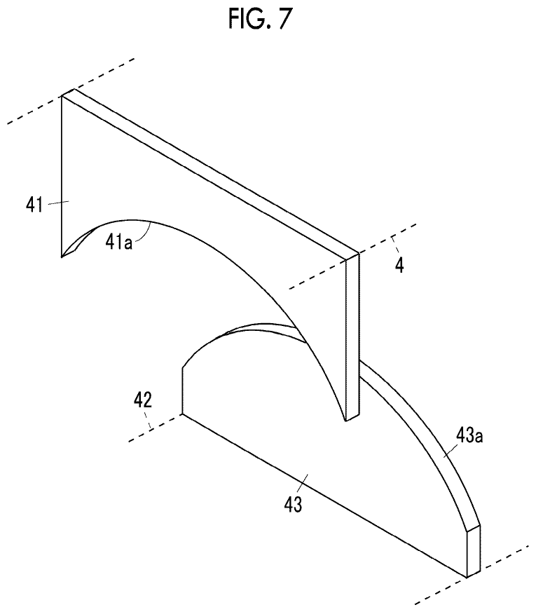

FIG. 7 is a diagram illustrating an abutting section of Example 1.

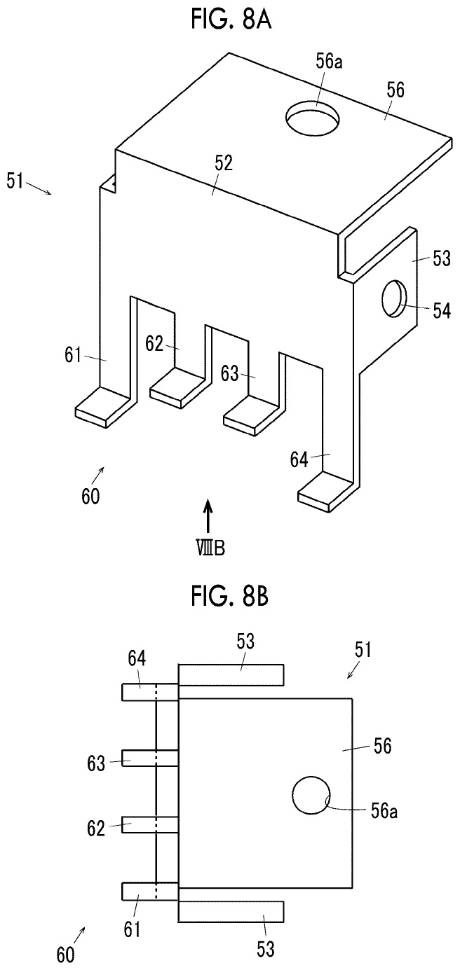

FIGS. 8A and 8B are diagrams illustrating a pulling section of Example 1, FIG. 8A is a perspective view, and FIG. 8B is a diagram viewed in a direction of an arrow VIIIB in FIG. 8A.

In order to illustrate a configuration for stretching the grid electrode, other members and portions that are not related to stretching are not shown in FIGS. 6 to 8B.

In FIG. 6, a spring mounting portion 40 as an example of a mounting target portion is formed on a side of the front end block 4 farther from an upper surface of the front end portion, that is, farther from the photoreceptor drum Pk.

In FIGS. 6 and 7, a front abutting portion 41 as an example of an abutting section is formed on a side of the front end block 4 closer to a lower surface of the front end portion, that is, closer to the photoreceptor drum Pk. The front abutting portion 41 is formed in a shape protruding downward (toward the photoreceptor drum Pk). In FIG. 7, a lower surface 41a of the front abutting portion 41 facing the photoreceptor drum Pk is formed of a curved surface that is curved downward as extending outward in the width direction (lateral direction) of the charger CCk. The lower surface 41a is set to a curved surface corresponding to the curvature of the surface of the cylindrical photoreceptor drum Pk.

A second front abutting portion 43 as an example of a second abutting section is formed on a front bearing portion 42 of the photoreceptor drum Pk at a position on the rear side of the front abutting portion 41. An upper surface 43a of the second front abutting portion 43 is formed of a curved surface corresponding to the curvature of the surface of the photoreceptor drum Pk, like the lower surface 41a of the front abutting portion 41.

The heights of the front abutting portion 41 and the second front abutting portion 43 are set such that the upper surface 43a of the second front abutting portion 43 is positioned above the lower surface 41a of the front abutting portion 41 in a state where the charger CCk is mounted on the image recording device U3.

Therefore, in Example 1, as shown in FIGS. 5A, 5B, and 6, the front abutting portion 41 and the second front abutting portion 43 are in contact with the hook portion 14 of the grid electrode 12 from above and below.

In FIG. 6, a pulling member 51 as an example of a pulling section is supported by a front end portion of the front end block 4.

In FIGS. 6, 8A, and 8B, the pulling member 51 includes a body portion 52 extending in the vertical direction. The body portion 52 of Example 1 is formed in the shape of a plate. Rotationally supported portions 53 extending rearward are formed on both left and right sides of the body portion 52. The rotationally supported portions 53 are rotatably supported by the front end block 4 via rotating shaft portions 54. Therefore, the pulling member 51 is rotatable about the rotating shaft portions 54.

A mounting target portion 56 extending rearward is formed at an upper end portion of the body portion 52. A spring mounting hole 56a is formed in the mounting target portion 56. A spring 57 as an example of a tension generating section is mounted between the mounting target portion 56 and the spring mounting portion 40.

A hook claw 60 as an example of a pulling portion is formed at a lower portion of the body portion 52. The hook claw 60 includes a first claw portion 61, a second claw portion 62, a third claw portion 63, and a fourth claw portion 64 corresponding to the first to fourth hook portions 16 to 19. Therefore, the first to fourth claw portions 61 to 64 can support the first to fourth hook portions 16 to 19 in a state where the first to fourth claw portions 61 to 64 penetrate the openings 16a to 19a of the first to fourth hook portions 16 to 19 and are caught by the first to fourth hook portions 16 to 19.

In Example 1, in regard to the lengths of the first to fourth claw portions 61 to 64 in the vertical direction, that is, the lengths of the first to fourth claw portions 61 to 64 extending toward the photoreceptor drum Pk, the lengths of the first and fourth claw portions 61 and 64 provided on both sides in the lateral direction are longer than the lengths of the second and third claw portions 62 and 63 on the inside in the lateral direction. That is, the lengths of the first to fourth claw portions 61 to 64 are set such that the lower ends of the first to fourth claw portions 61 to 64 correspond to the curvature of the surface of the photoreceptor drum Pk.

Further, in Example 1, all the positions of the first to fourth claw portions 61 to 64 in the front-rear direction are set to be identical. That is, the first to fourth claw portions 61 to 64 are disposed at positions aligned in the longitudinal direction of the grid electrode 12.

In FIG. 6, a positioning protruding portion 71 as an example of a portion to be positioned is formed on a lower surface of a rear end portion of the rear end block 3. The positioning protruding portion 71 is mounted in a state where the positioning protruding portion 71 penetrates the positioning opening 32 of the grid electrode 12.

A rear abutting portion 72 as an example of an abutting section is formed on a lower surface of the rear end block 3. Since the rear abutting portion 72 has a configuration identical to the configuration of the front abutting portion 41, the detailed description thereof will be omitted.

Further, a second rear abutting portion 74 as an example of a second abutting section is formed on a rear bearing portion 73 of the photoreceptor drum Pk. Since the second rear abutting portion 74 also has a configuration identical to the configuration of the second front abutting portion 43, the detailed description thereof will be omitted.

In FIGS. 5A, 5B, and 6, the rear abutting portion 72 and the second rear abutting portion 74 are in contact with the rear frame portion 31 of the grid electrode 12 from above and below. The rear abutting portion 72 and the second rear abutting portion 74 are in contact with the rear frame portion 31. In particular, in Example 1, the rear abutting portion 72 and the second rear abutting portion 74 are in contact with the rear frame portion 31 at positions on the rear side of the cut-out portions 33 and on the front side of the positioning opening 32.

An aspect in which the front abutting portion 41 and the second front abutting portion 43 are in contact with the hook portion 14 of the grid electrode 12 has been exemplified, but the present invention is not limited thereto. For example, an aspect in which a front frame portion identical to the rear frame portion 31 is formed between the net-like portion 13 and the hook portion 14 and any one or both of the front abutting portion 41 and the second front abutting portion 43 are in contact with the front frame portion may also be provided.

The pulling member 51, the spring 57, the spring mounting portion 40, and the like constitute a tension applying section 58 of Example 1 that applies tension to the grid electrode 12. The spring constant of the spring 57 may also be changed to adjust the tension of the grid electrode 12. Further, since the tension of the grid electrode 12 is reduced in a case where the spring 57 is removed and the pulling member 51 is rotated about the rotating shaft portions 54, the grid electrode 12 can be removed or replaced.

### Description of Cleaning Section

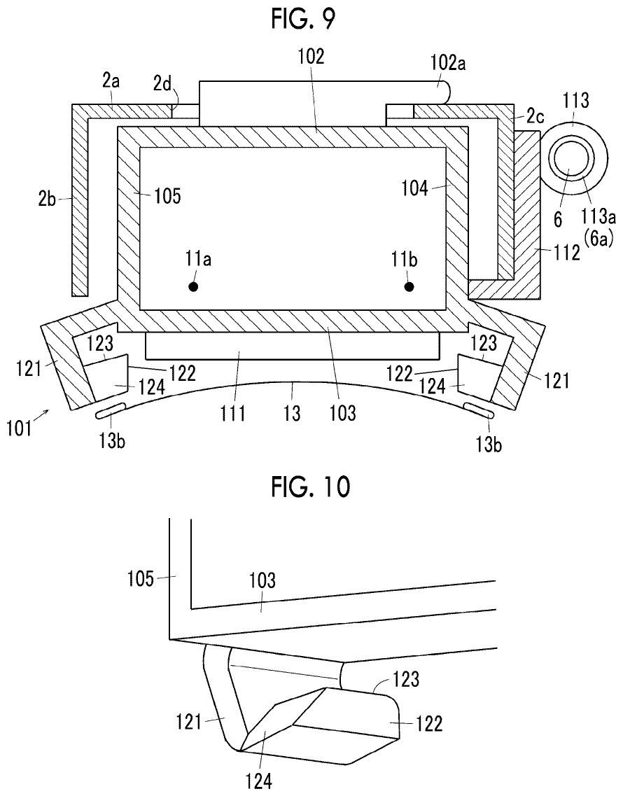

FIG. 9 is a cross-sectional view of a cleaning section of Example 1.

In FIGS. 3, 4, and 9, a charging cleaner 101 as an example of a cleaning section is disposed in the shield electrode 2. The charging cleaner 101 is an example of a moving section and includes an upper frame portion 102, a lower frame portion 103, a right frame portion 104, and a left frame portion 105 as an example of a frame body.

A portion 102a guided by the cleaner as an example of a cleaning guide section is formed on an upper portion of the upper frame portion 102. The portion 102a guided by the cleaner is formed in a shape in which the portion 102a guided by the cleaner penetrates the opening 2d of the shield electrode 2 upward and is then bent to the right. Therefore, the portion 102a guided by the cleaner is movable in the front-rear direction along the opening 2d of the shield electrode 2. That is, the charging cleaner 101 is guided in the front-rear direction along the opening 2d.

A cleaning pad 111 as an example of a cleaning body part is supported on a lower surface of the lower frame portion 103. The cleaning pad 111 comes into contact with the upper surface of the grid electrode 12, and can clean the grid electrode 12.

A drive connecting portion 112 that is formed to wrap around a lower end of the right wall portion 2c of the shield electrode 2 and extends upward is formed at a lower end of the right frame portion 104. A driven transmission portion 113 is formed at an upper portion of the drive connecting portion 112. The driven transmission portion 113 is formed in the shape of a cylinder extending in the front-rear direction. A thread groove 113a is formed in the driven transmission portion 113. The thread groove 113a meshes with the thread 6a of the shaft 6. Accordingly, the driven transmission portion 113 receives a force for moving the driven transmission portion 113 in the front-rear direction as the shaft 6 is rotated in a normal direction and a reverse direction. Therefore, in a case where the shaft 6 is rotated in the normal direction and the reverse direction, the charging cleaner 101 is moved in the front-rear direction (the longitudinal direction of the grid electrode 12).

FIG. 10 is a perspective view of a separation section of Example 1.

In FIGS. 9 and 10, separation connecting portions 121 and 121 protruding outward in the lateral direction are formed at lower end portions of the right and left frame portions 104 and 105. The separation connecting portions 121 and 121 are formed to wrap around the outer sides of the grid electrode 12 in the lateral direction (width direction) downward. Therefore, an interval between the inner sides of the separation connecting portions 121 and 121 in the lateral direction is formed to be wider than the width of the grid electrode 12 in the lateral direction.

Lifting blocks 122 and 122 as an example of an electrode moving section are formed at lower end portions of the separation connecting portions 121 and 121. The lifting blocks 122 and 122 are disposed on the inner sides of the lower ends of the separation connecting portions 121 and 121 in the lateral direction. In Example 1, the lifting blocks 122 and 122 are disposed to correspond to the positions of the cut-out portions 33 in the width direction.

Separation surfaces 123 and 123 as an example of a separation section are formed on the upper surfaces of the lifting blocks 122 and 122. The separation surfaces 123 and 123 are disposed above the grid electrode 12, that is, at positions away from the photoreceptor drum Pk. Inclined surfaces 124 and 124 as an example of a guide section are formed on the front sides of the separation surfaces 123 and 123 on the lifting blocks 122 and 122. The inclined surfaces 124 and 124 are inclined downward, that is, in a direction approaching the photoreceptor drum Pk toward the front side. Lower ends of the inclined surfaces 124 and 124 are disposed below the grid electrode 12, that is, at positions close to the photoreceptor drum Pk.

### Action of Example 1

In the charger CCk of Example 1 having the above-described configuration, the hook portion 14 provided at the front end portion of the grid electrode 12 is mounted on the hook claw 60 in a state where the positioning opening 32 provided at the rear end is supported by the positioning protruding portion 71. In a case where the hook portion 14 is mounted on the hook claw 60, the hook portion 14 is pulled forward by a spring force of the spring 57. Therefore, tension acts on the grid electrode 12 in the front-rear direction.

The front abutting portion 41, the second front abutting portion 43, the rear abutting portion 72, and the second rear abutting portion 74 are in contact with the front and rear end portions of the grid electrode 12 of Example 1. Therefore, the grid electrode 12 is deformed along the surfaces of the front abutting portion 41 and the like in the lateral direction, and is held in a state where the grid electrode 12 is curved in a shape along the surface of the photoreceptor drum Pk.

### Operation of Charging Cleaner

The charging cleaner 101 is operated during cleaning in a case where an image is not formed. In a case where an image is formed, the charging cleaner 101 waits at a standby position provided at a rear end portion of the charger CCk. In Example 1, the standby position is set to a position where the lifting blocks 122 and 122 are inserted into the cut-out portions 33. Therefore, at the standby position, the lifting blocks 122 and 122 are in a state where the lifting blocks 122 and 122 are not in contact with the grid electrode 12. Further, the cleaning pad 111 is also not in contact with the grid electrode 12. Therefore, the charging cleaner 101 does not affect the curved state of the grid electrode 12. Furthermore, the charging cleaner 101 also hardly affects the electrical state of the grid electrode 12 to which a voltage is applied in a case where an image is formed.

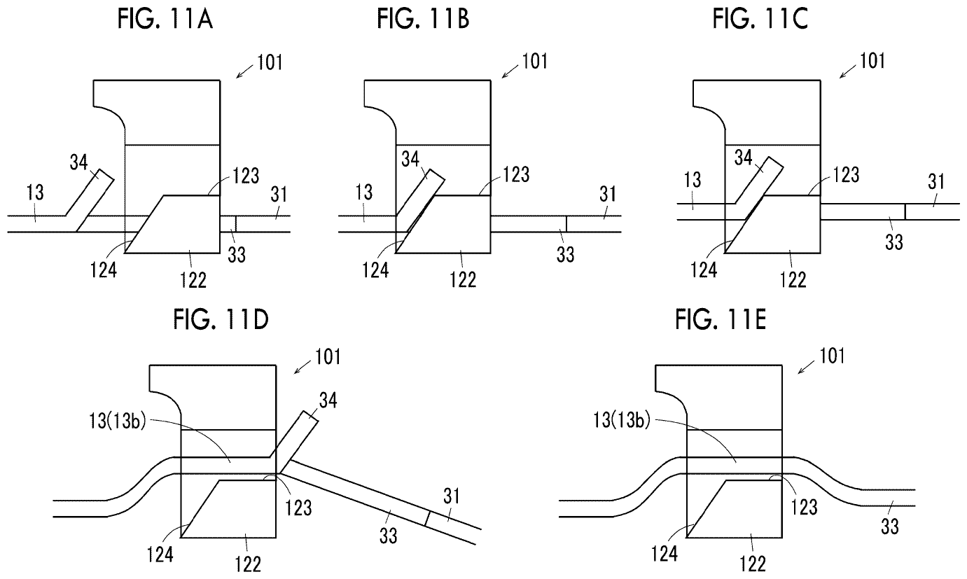

FIGS. 11A to 11E are diagrams illustrating an operation of the cleaning section of Example 1, FIG. 11A is a diagram illustrating a state where the cleaning section is moved to the standby position, FIG. 11B is a diagram illustrating a state where the cleaning section is moved forward from the standby position and the grid guide portions are in contact with the inclined surfaces, FIG. 11C is a diagram illustrating a state where the cleaning section is further moved forward from the state of FIG. 11B and the grid guide portions begin to be pushed upward by the inclined surfaces, FIG. 11D is a diagram illustrating a state where the cleaning section is further moved forward from the state of FIG. 11C and the grid electrodes are lifted upward from separation surfaces, and FIG. 11E is a diagram illustrating a state where the cleaning section is further moved forward from the state of FIG. 11D.

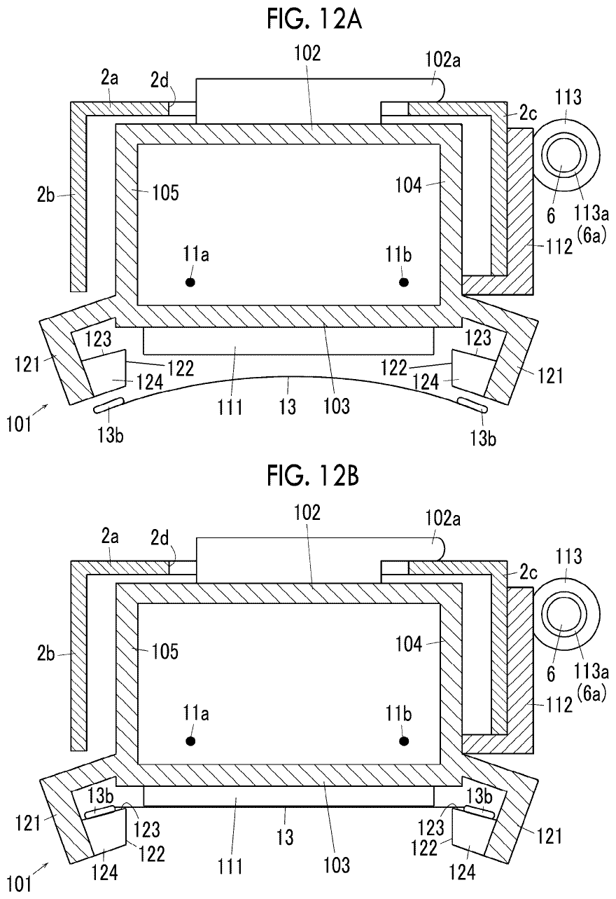

FIGS. 12A and 12B are cross-sectional views of the cleaning section in a case where the cleaning section is operated, FIG. 12A is a cross-sectional view showing a state where the cleaning section is moved to the standby position, and FIG. 12B is a cross-sectional view showing the state of FIGS. 11D and 11E.

In FIGS. 11A and 11B, in a case where cleaning is started, the motor 9 for an electrode cleaner is rotationally driven in a normal direction and the charging cleaner 101 is moved forward. In FIGS. 11B and 11C, in a case where the charging cleaner 101 is moved forward, the inclined surfaces 124 and 124 come into contact with the grid guide portions 34. In FIGS. 11C and 11D, in a case where the charging cleaner 101 is further moved forward, the grid guide portions 34 are guided by the inclined surfaces 124 and 124 and the edge portions 13b of the both end portions of the grid electrode 12 are guided by the separation surfaces 123 and 123. Accordingly, both end portions of the grid electrode 12 in the width direction are pushed from the inclined surfaces 124 and 124 to the separation surfaces 123 and 123 and are lifted up (in a direction away from the photoreceptor drum Pk). Therefore, the grid electrode 12 is bent from a curved state shown in FIG. 12A to a flat state shown in FIG. 12B. That is, the grid electrode 12 are pushed by the lifting blocks 122 and 122 such that the curvature of the grid electrode 12 is reduced.

In FIG. 12B, portions of the grid electrode 12 that are pushed by the separation surfaces 123 and 123 are in a state close to the shape of a flat plate and come into contact with the cleaning pad 111. Therefore, the surface of the grid electrode 12 is cleaned by the cleaning pad 111.

In a case where the charging cleaner 101 is moved to the front end, the motor 9 for an electrode cleaner is driven in a reverse direction and the charging cleaner 101 is moved rearward. Then, in a case where the charging cleaner 101 returns to the standby position, a cleaning operation ends. A case where the charging cleaner 101 reciprocates once in the cleaning operation has been exemplified, but an aspect in which the charging cleaner 101 reciprocates a plurality of times can also be adopted.

Since the grid electrode 12 of the charger CCk is curved along the photoreceptor drum Pk, a distance between the photoreceptor drum Pk and the grid electrode 12 is made uniform from the upstream to the downstream in the rotation direction of the photoreceptor drum Pk. Accordingly, charging efficiency can be improved as compared to a case where the grid electrode 12 is not curved. In particular, as the rotational speed of the photoreceptor drum Pk is higher, the charger CCk having higher charging efficiency is required.

In the charger CCk, discharge products are generated as electricity is discharged during use. In a case where the discharge products adhere to the grid electrode 12, poor charging is likely to occur. Therefore, the grid electrode 12 needs to be periodically cleaned. In a case where the grid electrode 12 is to be cleaned in a curved state, the cleaner also needs to be curved. In a case where the curvature of the grid electrode and the curvature of the cleaner do not coincide with each other, a portion where the contact pressure is high and a portion where the contact pressure is low are generated. For this reason, poor cleaning and cleaning unevenness may be caused.

In the technique disclosed in JP 2012-185299A (Paragraph 0057 to 0075 and FIG. 3 to 7), the curved grid electrode plate (104) is caused to return to the shape of a flat plate by a cam (108A). However, a complicated mechanism, a driving component, and a space are required to use the cam mechanism. Therefore, a breakdown may be likely to occur and manufacturing costs may be increased. Even in the technique disclosed in JP2013-186269A (Paragraph 0020 to 0037, FIG. 2 to 4, FIG. 6, and FIG. 9 to 15), a mechanism for operating the second cleaning pad (72) is required.

In the techniques described in JP 2012-185299A (Paragraph 0057 to 0075 and FIG. 3 to 7) and JP 2013-186269A (Paragraph 0020 to 0037, FIG. 2 to 4, FIG. 6, and FIG. 9 to 15), a mechanism that is movable to deform the grid electrode during cleaning but to separate the cleaning mechanism from the grid electrode or the photoreceptor drum while making the grid electrode be in a curved state during non-cleaning is adopted. Therefore, in the related art disclosed in JP2012-185299A (Paragraph 0057 to 0075 and FIG. 3 to 7) and JP2013-186269A (Paragraph 0020 to 0037, FIG. 2 to 4, FIG. 6, and FIG. 9 to 15), a mechanism or a driving component that is movable to make the grid electrode flat is used.

On the other hand, in Example 1, the lifting blocks 122 provided in the charging cleaner 101 pushes the grid electrode 12 in a direction away from the photoreceptor drum Pk with the movement of the charging cleaner 101, and the grid electrode 12 is cleaned in a state close to the shape of a flat plate. The cleaning mechanism is simplified as compared to a case where a mechanism for deforming the grid electrode 12 over the entire longitudinal direction is used to ensure a distance between the photoreceptor drum Pk and the charging cleaner 101 in a case where the grid electrode 12 facing the photoreceptor drum Pk is cleaned.

### Modification Examples

Example of the present invention has been described in detail above. However, the present invention is not limited to Example described above, and can have various modifications without departing from the scope of the present invention described in claims. Modification Examples (H01) to (H06) of the present invention will be exemplified below.
(H01) In Example described above, the present invention is not limited to the copying machine as an example of the image forming apparatus and can also be applied to image forming apparatuses, such as a printer and a FAX. Further, the present invention is not limited to the color image forming apparatus and can also be applied to a monochrome image forming apparatus. Furthermore, the present invention is not limited to the tandem type image forming apparatus, and can also be applied to a rotary type image forming apparatus.
(H02) A case where the wire electrode 11 is two wire rods has been exemplified in Example described above. However, the present invention is not limited thereto, and a configuration in which the wire electrode 11 includes one or three or more wire rods or the like can also be adopted.
(H03) A configuration in which the shield electrode 2 is not provided can also be adopted in Example described above. (H04) The scorotron type charger has been exemplified in Example described above, but the present invention is not limited thereto. For example, other discharge type chargers can also be used as a static eliminator or an auxiliary charger for the photoreceptor drums Py to Pk or the recording sheet S, the transfer modules T1y to T1k and T2, and the like.
(H05) The net-like grid electrode 12 has been exemplified as an example of the control electrode in Example described above, but the present invention is not limited thereto. For example, the present invention can also be applied to a control electrode in a form (vertical stripe shape) in which a plurality of wires extend in a longitudinal direction.
(H06) In Example described above, for example, it is desirable that the lifting blocks 122 are not in contact with the grid electrode 12 at the standby position, but a configuration in which the lifting blocks 122 are in contact with the grid electrode 12 at the standby position can also be adopted. Therefore, a configuration in which the cut-out portions 33 are not provided can also be adopted. Further, the inclined surfaces 124 and the grid guide portions 34 also do need to be provided in this case.

### Supplementary Note

(((1)))

A charging device comprising:
a discharge electrode;
a control electrode that is disposed between the discharge electrode and a member to be charged, controls discharge of electricity from the discharge electrode, and is supported in a state where the control electrode is curved along a surface shape of the member to be charged in a lateral direction; and
a cleaning section including a moving section that is supported to be movable in a longitudinal direction of the control electrode, a separation section that is fixedly supported by the moving section and comes into contact with the control electrode to push the control electrode in a direction away from the member to be charged, and a cleaning body part that comes into contact with the control electrode separated from the member to be charged by the separation section to clean the control electrode.
   (((2)))

The charging device according to (((1))),
wherein the cleaning section includes a guide section that is inclined in a direction approaching the member to be charged toward a front side with respect to a movement direction of the moving section at a time of cleaning and guides the control electrode toward the separation section.
   (((3)))

The charging device according to (((2))),
wherein the control electrode includes an opening portion that is formed to correspond to a standby position of the moving section at a time of non-cleaning and allows a non-contact state between the cleaning section and the control electrode to be held.
   (((4)))

The charging device according to (((3))), further comprising:
a section to be guided that is disposed at a position on a front side of the opening portion in the movement direction of the moving section at the time of cleaning, is inclined in a direction away from the member to be charged toward a rear side with respect to the movement direction of the moving section at the time of cleaning, and is guided by the separation section with a movement of the moving section.
   (((5)))

The charging device according to any one of (((1))) to (((4))),
wherein the separation section pushes the control electrode such that a curvature of the control electrode is reduced.
   (((6)))

The charging device according to (((5))),
wherein the separation section comes into contact with both end portions of the control electrode in the lateral direction and pushes the control electrode such that the curvature of the control electrode is reduced.
   (((7)))

An image forming apparatus comprising:
a member to be charged that is formed of an image holding section;
   a charging device according to any one of (((1))) to (((6))) that charges the image holding section;
a latent image forming section that forms a latent image on the image holding section;
a developing section that develops the latent image formed on the image holding section;
a transfer section that transfers an image developed by the developing section onto a medium; and
a fixing section that fixes the image to the medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A charging device comprising:
a discharge electrode;
a control electrode that is disposed between the discharge electrode and a member to be charged, controls discharge of electricity from the discharge electrode, and is supported in a state where the control electrode is curved along a surface shape of the member to be charged in a lateral direction; and
a cleaning section including a moving section that is supported to be movable in a longitudinal direction of the control electrode, a separation section that is fixedly supported by the moving section and comes into contact with the control electrode to push the control electrode in a direction away from the member to be charged, and a cleaning body part that comes into contact with the control electrode separated from the member to be charged by the separation section to clean the control electrode.

2. The charging device according to claim 1,
wherein the cleaning section includes a guide section that is inclined in a direction approaching the member to be charged toward a front side with respect to a movement direction of the moving section at a time of cleaning and guides the control electrode toward the separation section.

3. The charging device according to claim 2,
wherein the control electrode includes an opening portion that is formed to correspond to a standby position of the moving section at a time of non-cleaning and allows a non-contact state between the cleaning section and the control electrode to be held.

4. The charging device according to claim 3, further comprising:
a section to be guided that is disposed at a position on a front side of the opening portion in the movement direction of the moving section at the time of cleaning, is inclined in a direction away from the member to be charged toward a rear side with respect to the movement direction of the moving section at the time of cleaning, and is guided by the separation section with a movement of the moving section.

5. The charging device according to claim 1,
wherein the separation section pushes the control electrode such that a curvature of the control electrode is reduced.

6. The charging device according to claim 5,
wherein the separation section comes into contact with both end portions of the control electrode in the lateral direction and pushes the control electrode such that the curvature of the control electrode is reduced.

7. An image forming apparatus comprising:
a member to be charged that is formed of an image holding section;
a charging device according to claim 1 that charges the image holding section;
a latent image forming section that forms a latent image on the image holding section;
a developing section that develops the latent image formed on the image holding section;
a transfer section that transfers an image developed by the developing section onto a medium; and
a fixing section that fixes the image to the medium.

8. An image forming apparatus comprising:
a member to be charged that is formed of an image holding section;
a charging device according to claim 2 that charges the image holding section;
a latent image forming section that forms a latent image on the image holding section;
a developing section that develops the latent image formed on the image holding section;
a transfer section that transfers an image developed by the developing section onto a medium; and
a fixing section that fixes the image to the medium.

9. An image forming apparatus comprising:
a member to be charged that is formed of an image holding section;
a charging device according to claim 3 that charges the image holding section;
a latent image forming section that forms a latent image on the image holding section;
a developing section that develops the latent image formed on the image holding section;
a transfer section that transfers an image developed by the developing section onto a medium; and
a fixing section that fixes the image to the medium.

10. An image forming apparatus comprising:
a member to be charged that is formed of an image holding section;
a charging device according to claim 4 that charges the image holding section;
a latent image forming section that forms a latent image on the image holding section;
a developing section that develops the latent image formed on the image holding section;
a transfer section that transfers an image developed by the developing section onto a medium; and
a fixing section that fixes the image to the medium.

11. An image forming apparatus comprising:
a member to be charged that is formed of an image holding section;
a charging device according to claim 5 that charges the image holding section;
a latent image forming section that forms a latent image on the image holding section;
a developing section that develops the latent image formed on the image holding section;
a transfer section that transfers an image developed by the developing section onto a medium; and
a fixing section that fixes the image to the medium.

12. An image forming apparatus comprising:
a member to be charged that is formed of an image holding section;
a charging device according to claim 6 that charges the image holding section;
a latent image forming section that forms a latent image on the image holding section;
a developing section that develops the latent image formed on the image holding section;
a transfer section that transfers an image developed by the developing section onto a medium; and
a fixing section that fixes the image to the medium.
